(19) United States
(12) Patent Application Publication
(10) Pub. No.: US 2003/0226791 A1
(43) Pub. Date: Dec. 11, 2003

(54) Fuel supply apparatus

(75) Inventor: Akihiro Kimura, Sashima-gun (JP)

Correspondence Address: OLIFF & BERRIDGE, PLC, P.O. BOX 19928, ALEXANDRIA, VA, 22320, US

(73) Assignee: KYOSAN DENKI CO., LTD., Sashima-gun (JP)

(21) Appl. No.: 10/443,967

(22) Filed: May 23, 2003

(30) Foreign Application Priority Data
Jun. 7, 2002 (JP) 2002-167290

(51) Int. Cl. E02B 5/08; B01D 33/00

(52) U.S. Cl. 210/155

(57) ABSTRACT

A fuel supply apparatus includes a suction filter; a fuel pump which is connected to the suction filter by a connecting pipe through which fuel that has passed through the suction filter is discharged; a fuel passage which protrudes from an upper portion of the fuel pump; and a one-way valve which is provided at an inlet portion of the fuel passage. In the fuel supply apparatus, a high-pressure filter is provided in a fuel passage on a downstream side of the one-way valve, and the suction filter and the high-pressure filter in the fuel passage remove dust in the fuel.

### INCORPORATION BY REFERENCE

The disclosure of Japanese Patent Application No. 2002-167290 filed on Jun. 7, 2002 including the specification, drawings and abstract is incorporated herein by reference in its entirety.

### BACKGROUND OF THE INVENTION

1. Field of the Invention

The invention relates to a filter for fuel filtration intended mainly for protection of an engine in a fuel supply apparatus provided in a fuel tank.

2. Description of the Related Art

A conventional fuel supply apparatus A provided in a fuel tank includes a suction filter B, a fuel pump C, a discharging portion D, a one-way valve, a high-pressure filter E, and a delivery pipe I, as shown in FIG. 6. The suction filter B is provided in an inner side of a bottom portion of the fuel tank. The fuel pump C supplies a suction force and a delivery force for delivering fuel that has passed through the suction filter B and has been filtrated. The discharging portion D discharges the fuel that has been sucked. The one-way valve is provided in the discharging portion D, and maintains a fuel pressure in a fuel supply pipe leading to an engine after the engine (the fuel pump) is stopped so as to prevent a delay in start of the engine when the engine is restarted. The high-pressure filter E is provided in a cylindrical body so as to further filtrate the discharged fuel. The delivery pipe I delivers the fuel that has been filtrated by the high-pressure filter E toward the engine.

The suction filter B in the aforementioned fuel supply apparatus A has a planiform shape, and has a large surface area so as to filtrate fuel. The suction filter B prevents dust in the fuel from being delivered to the fuel pump C and the engine. Pores of a filter medium in the suction filter B have an average dimension of approximately 60 microns. Thus, the suction filter B captures relatively coarse dust.

The fuel that has been filtrated by the aforementioned suction filter B is delivered from the discharging portion D to the high-pressure filter E by the fuel pump C.

The high-pressure filter E captures the dust that has not been captured by the aforementioned suction filter B, abrasion powder generated in the fuel pump C, and the like. Accordingly, a filter medium in the high-pressure filter E has smaller pores than that of the filter medium in the aforementioned suction filter B. The pores of the filter medium in the high-pressure filter E have an average dimension of approximately 20 microns. Thus, the high-pressure filter E removes fine dust in the fuel, and prevents the dust from being delivered to the engine (an injector).

The aforementioned high-pressure filter E is provided in a filter chamber constituting a side wall of the cylindrical body that is formed so as to surround the fuel pump C. The fuel is discharged from a fuel delivery outlet F of the discharging portion D formed in an upper portion of the fuel pump C, passes through a fuel passage G, and is introduced into the filter chamber. Then, the fuel passes through the high-pressure filter E from the upper portion thereof to the lower portion thereof such that fine dust is removed. The fuel from which the fine dust has been removed is delivered to the delivery pipe I through a fuel passage in a bottom portion of the filter chamber, and is introduced into the engine (the injector).

As described above, in the conventional fuel supply apparatus A shown in FIG. 6, the high-pressure filter E is provided in the filter chamber constituting the side wall of the cylindrical body in which the fuel pump C is mounted, so as to capture the dust that has not been captured by the suction filter B, the abrasion powder generated in the fuel pump C, and the like. Accordingly, the entire fuel supply apparatus A has a large diameter, and is of a large size.

In these years, a fuel supply apparatus having the same shape as that of the aforementioned fuel supply apparatus is employed, particularly in an internal combustion engine of a small displacement, such as an engine of a two-wheeled vehicle, even when an amount of dust to be removed during lifetime that is estimated based on the useful life of the two-wheeled vehicle or the like is small. However, it is difficult to reduce the size and weight of the fuel supply apparatus while maintaining the capacity of the fuel pump C.

Also, in the conventional fuel supply apparatus A, the high-pressure filter E is provided in the filter chamber, as described above. Accordingly, the fuel passage, which includes the passage leading from the fuel pump C to the high-pressure filter E and the passage leading from the high-pressure filter E, is formed so as to be long and complicated passage with many bent portions. Thus, the weight and size of the fuel supply apparatus is inhibited from being reduced, and loss of pressure due to an inner wall of the passage frequently occurs.

### SUMMARY OF THE INVENTION

In view of the above, it is an object of the invention to make a diameter of an entire fuel supply apparatus small such that a size and a weight thereof are reduced by changing a role of a filter and considering a position at which the filter is provided, and to reduce loss of pressure on fuel by configuring a simple passage, so that the invention is effective particularly for a fuel supply apparatus for supplying a small amount of fuel.

A fuel supply apparatus according to an embodiment of the invention includes a fuel pump which discharges fuel, a cover portion which is formed above the fuel pump, a fuel passage which is provided in the cover portion; and a high-pressure filter provided in at least one of the fuel pump and the fuel passage, and which removes dust in the fuel discharged from the fuel pump.

### BRIEF DESCRIPTION OF THE DRAWINGS

FIG. 1 is a partial sectional side view showing a fuel supply apparatus according to an embodiment of the invention;

FIG. 2 is a partial sectional side view showing a fuel supply apparatus according to another embodiment of the invention;

FIG. 3 is a partial sectional side view showing a fuel supply apparatus according to a further embodiment of the invention;

FIG. 4 is a partial sectional side view showing a fuel supply apparatus according to a further embodiment of the invention;

FIG. 5 is a partial sectional side view showing a fuel supply apparatus according to a further embodiment of the invention; and

FIG. 6 is a side view showing a conventional fuel supply apparatus.

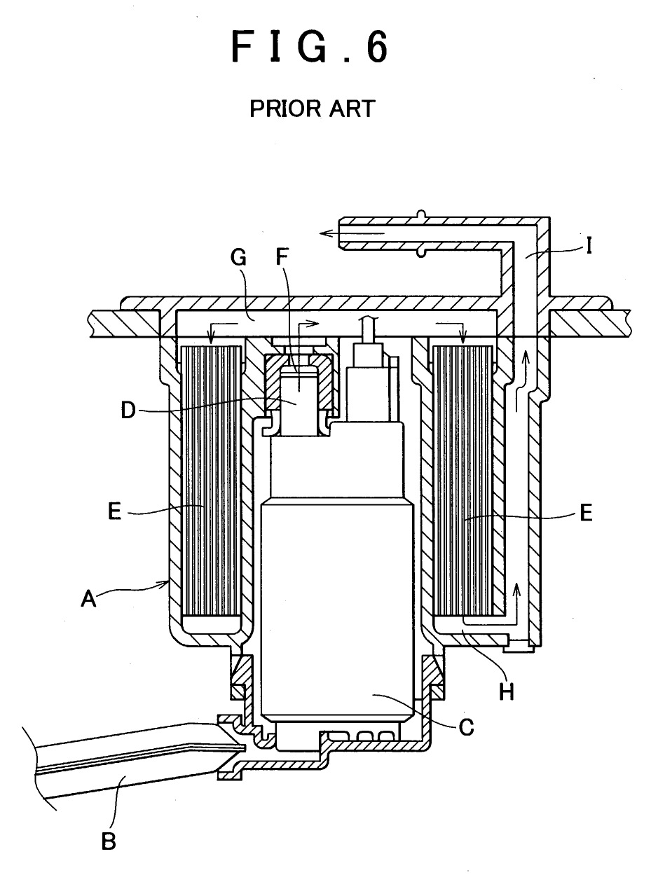

### DETAILED DESCRIPTION OF THE PREFERRED EMBODIMENTS

Hereinafter, embodiments of the invention will be described with reference to the accompanying drawings.

[First Embodiment]

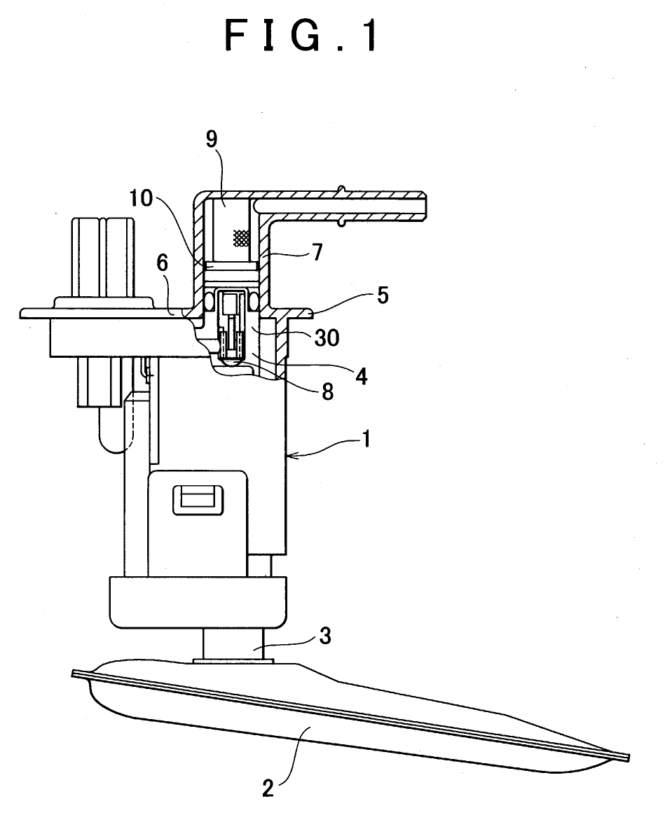

FIG. 1 shows a partial sectional side view showing a fuel supply apparatus 1 according to a first embodiment of the invention. The fuel supply apparatus 1 according to the first embodiment mainly includes a suction filter 2, a fuel pump 4, a cover portion 6, a fuel passage 7, a one-way valve 8, and a high-pressure filter 9. The fuel pump 4 is connected to the suction filter 2 by a connecting pipe 3 that supplies a suction force for discharging the fuel that has passed through the suction filter 2 and has been filtrated. A flange 5 is formed at a periphery of the cover portion 6 so as to protrude therefrom. The flange 5 is used for installing the fuel supply apparatus 1 in a fuel tank by fixing an upper portion of the fuel pump 4. The fuel passage 7 is tubular and protrudes from the upper portion of the cover portion 6. The one-way valve 8 is provided in a discharging pipe 30 which protrudes above the fuel pump 4. The high-pressure filter 9 is provided in the fuel passage 7 on the downstream side of the one-way valve 8.

The suction filter 2 of the fuel supply apparatus 1 is provided in an inner side of a bottom portion of the fuel tank so as to filtrate fuel in the fuel tank. The suction filter 2 has a small thickness, a planiform shape, and a large surface area such that the suction filter 2 can suck a larger amount of fuel and the height of the fuel supply apparatus is small.

Also, the suction filter 2 is formed as a bag-shaped member. A protector or the like is provided inside the suction filter 2, whereby portions of a filter medium constituting the bag-shaped member around the protector or the like are prevented from adhering to each other. The filter medium that can remove dust in the fuel efficiently is employed. The filter medium is a mesh or a nonwoven fabric. Pores of the filter medium have an average dimension of approximately 20 microns or smaller, which is substantially the same as that of pores of a filter medium of the high-pressure filter. Thus, the suction filter 2 can capture fine dust as well as coarse dust in the filter. Accordingly, a diameter of the largest dust particle that can pass through the suction filter 2 is approximately 20 microns or smaller.

The suction filter 2 is connected to the fuel pump 4 by the connecting pipe 3, and filtrates the fuel in the fuel tank. The fuel is delivered upward from the suction filter 2 by the delivery force of the fuel pump 4. An opening for delivering the fuel is formed in the upper portion of the fuel pump 4, and is connected to the fuel passage 7 formed in the cover portion 6.

The one-way valve 8 is provided in a discharging pipe 30 which serves as the fuel passage at an oil feed pipe inlet of the fuel pump. Further, the high-pressure filter 9 is provided in a pipe on the downstream side of the one-way valve 8.

The high-pressure filter 9 is a cartridge surrounded by a mesh or a nonwoven fabric, and can be provided so as to be fitted in the fuel passage 7. In the high-pressure filter 9 shown in FIG. 1, a collar portion 10 is formed on a bottom portion side. The collar portion 10 is used as engagement means for engaging with a stepped portion in the inner side of the fuel passage so that the high-pressure filter 9 is fixed and disposed in the fuel passage.

The high-pressure filter 9 is made of a mesh or a nonwoven fabric. Pores of the filter medium of the high-pressure filter 9 have an average dimension of approximately 20 microns or smaller, as in the case of the filter medium of the suction filter 2. Thus, the high-pressure filter 9 can capture fine dust. Accordingly, dust as abrasion powder and so on, generated in the fuel pump 4 and the like can be captured.

As described above, the suction filter 2 filtrates fine dust as abrasion powder and so on, in the fuel tank. The fuel that has been delivered to the downstream of the suction filter 2 is delivered to the fuel passage 7 that protrudes from the upper portion of the fuel pump 4. Then, the fuel passes through the one-way valve 8, and is filtrated by the high-pressure filter 9 provided in the fuel passage 7 so that abrasion powder generated in the fuel pump 4 and the like can be captured. Accordingly, the fuel supply apparatus thus configured removes almost all dust as abrasion powder and so on, in the fuel, and prevents dust from being delivered to the engine (the injector). Moreover, the fuel supply apparatus described above provides the high-pressure filter 9 in the fuel passage 7. Therefore, the fuel supply apparatus does not need to establish a filter chamber for including the high-pressure filter, not like the prior art.

[Second Embodiment]

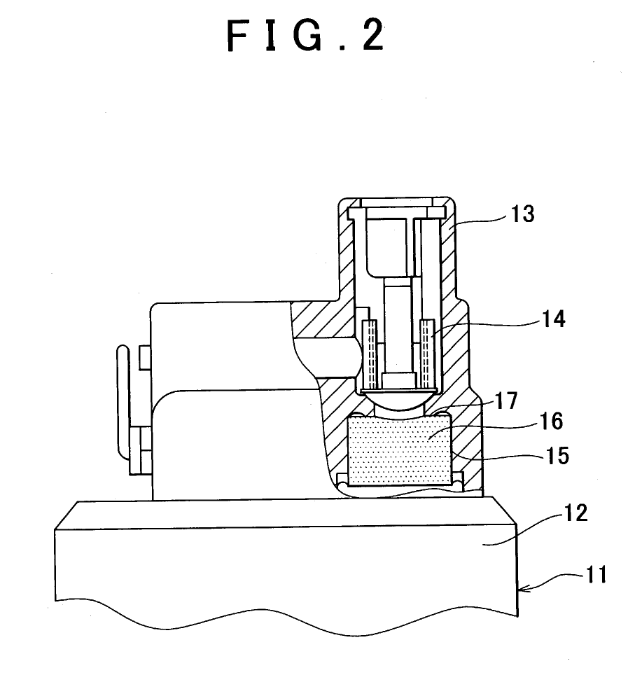

FIG. 2 is a partial sectional side view showing an upper side of a fuel pump which is one component of a fuel supply apparatus according to another embodiment of the invention.

As in the first embodiment, a fuel supply apparatus 11 in the second embodiment mainly includes a suction filter, a fuel pump 12, a discharging pipe 13, a fuel passage, a one-way valve 14, and a high-pressure filter 16. The fuel pump 12 is connected to the suction filter by a connecting pipe that supplies a suction force for allowing the suction filter to discharge the fuel that has passed through the suction filter and has been filtrated. A flange is formed at a periphery of the cover portion so as to protrude therefrom. The flange is used for installing the fuel supply apparatus 11 in a fuel tank by fixing an upper portion of the fuel pump 12. The one-way valve 14 is provided in a discharging pipe 13 which protrudes above the fuel pump 12. The high-pressure filter 16 is provided in a space portion 15 which is in the fuel pump 12, on the upstream side of the one-way valve 14.

After the fuel passes through the suction filter, it passes through the high-pressure filter 16 that is provided in the space portion 15 between the fuel pump 12 and the one-way valve 14 formed in an upper portion inside of the fuel pump 12 as shown in FIG. 2, whereby dust in the fuel is removed. The space portion 15 is formed so as to be narrow on the one-way valve 14 side, and an inner wall 17 is formed so as to protrude in the space portion 15. Therefore, the one-way valve 14 is engaged with the inner wall 17. Accordingly, the one-way valve 14 does not drop in the space portion 15.

Each of the filter mediums of the suction filter and the high-pressure filter 16 provided in the space portion 15 is a mesh or a nonwoven fabric whose pores have the same average dimension as in the first embodiment. The suction filter can capture fine dust as well as coarse dust in the fuel tank. The high-pressure filter 16 can capture dust as abrasion powder and so on, generated in the fuel pump 12, and the like.

Accordingly, the fuel supply apparatus thus configured removes almost all dust in the fuel, and prevents dust from being delivered to the engine (the injector).

[Third Embodiment]

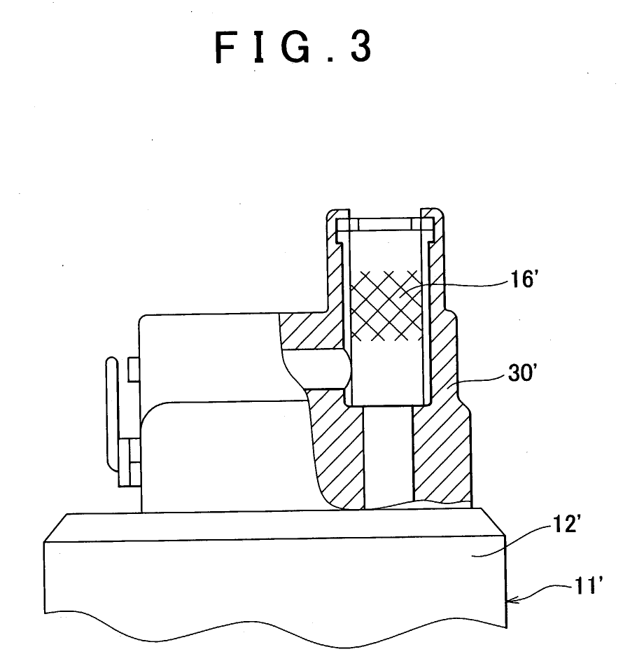

FIG. 3 shows a partial sectional side view showing an upper side of a fuel pump which is one component of a fuel supply apparatus according to a further embodiment of the invention.

A fuel supply apparatus 11′ in the third embodiment mainly includes a suction filter, a fuel pump 12′, a cover portion, a discharging pipe 30′, and a high-pressure filter 16′. The fuel pump 12′ is connected to the suction filter by a connecting pipe that supplies a suction force for allowing the suction filter to discharge the fuel that has passed through the suction filter and has been filtrated. A flange is formed at a periphery of the cover portion so as to protrude therefrom. The flange is used for installing the fuel supply apparatus 11′ in a fuel tank by fixing an upper portion of the fuel pump 12′. The discharging pipe 30′ protrudes upward from the fuel pump 12′. The high-pressure filter 16′ is provided in the discharging pipe 30′.

After the fuel passes through the suction filter, it passes through the high-pressure filter 16′ provided in the discharging pipe 30′ formed above the fuel pump 12′, whereby dust in the fuel is removed.

Each of the filter mediums of the suction filter and the high-pressure filter 16′ provided in the fuel passage is a mesh or a nonwoven fabric whose pores have the same average dimension as in the first embodiment and the second embodiment. The suction filter can capture fine dust as well as coarse dust in the fuel tank. The high-pressure filter 16′ can capture dust as abrasion powder and so on, generated in the fuel pump 12′.

Accordingly, the fuel supply apparatus thus configured removes almost all dust in the fuel, and prevents dust from being delivered to the engine (the injector).

[Fourth Embodiment]

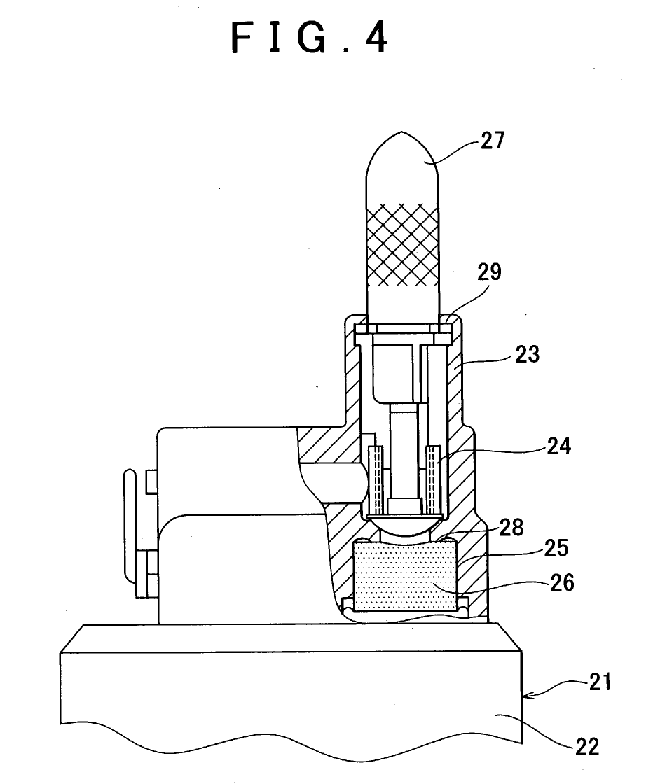

FIG. 4 is a partial sectional side view showing an upper side of a fuel pump which is one component of a fuel supply apparatus according to a further embodiment of the invention. As in the first to third embodiments, a fuel supply apparatus 21 in the fourth embodiment mainly includes a suction filter, a fuel pump 22, a cover portion, a fuel passage, a one-way valve 24, and high-pressure filters 26, 27. The fuel pump 22 is connected to the suction filter by a connecting pipe that supplies a suction force for allowing the suction filter to discharge the fuel that has passed through the suction filter and has been filtrated. A flange is formed at a periphery of the cover portion so as to protrude therefrom. The flange is used for installing the fuel supply apparatus 21 in a fuel tank by fixing an upper portion of the fuel pump 22. The fuel passage protrudes from the upper portion of the fuel pump 22. The one-way valve 24 is provided in a discharging pipe 23 which is a portion of the fuel passage. The high-pressure filter 26 is provided in a space portion 25 on the upstream side of the one-way valve 24. The high-pressure filter 27 is provided on the downstream side of the one-way valve 24.

After the fuel passes through the suction filter, it passes through the high-pressure filter 26 that is provided in the space portion 25 between the fuel pump 22 and the one-way valve 24 formed on the downstream side of the fuel pump 22 as shown in FIG. 4, whereby dust in the fuel is removed. The space portion 25 is formed so as to be narrow on the one-way valve 24 side, and an inner wall 28 is formed so as to protrude. Therefore, the one-way valve 24 is engaged with the inner wall 28. Accordingly, the one-way valve 24 does not drop in the space portion 25.

Also, the high-pressure filter 27 is provided in the fuel passage on the downstream side of the one-way valve 24.

The high-pressure filter 27 is a cartridge surrounded by a mesh or a nonwoven fabric, and can be provided so as to be fitted in the fuel passage. In the high-pressure filter 27 shown in FIG. 4, a collar portion 29 is formed on the bottom portion side. The collar portion 29 is used as engagement means for engaging with a stepped portion in the inner side of the fuel passage so that the high-pressure filter 27 is fixed and disposed in the fuel passage.

Each of the filter mediums of the suction filter, the high-pressure filter 26 provided in the space portion 25, and the high-pressure filter 27 fixed in the fuel passage is a mesh or a nonwoven fabric whose pores have the same average dimension as in the first to third embodiments. The suction filter can capture fine dust as well as coarse dust in the fuel tank. The high-pressure filters 26, 27 can capture dust as abrasion powder and so on, generated in the fuel pump 22.

Accordingly, the fuel supply apparatus thus configured removes almost all dust in the fuel, and prevents dust from being delivered to the engine (the injector).

Also, according to the fourth embodiment of the invention, the high-pressure filters are provided on the downstream side and the upstream side of the one-way valve so as to be adjacent to the one-way valve. Accordingly, the size of the high-pressure filter can be increased, and the useful life of the high-pressure filter for capturing dust in the fuel can be prolonged.

According to the fuel supply apparatus thus configured in the embodiment, it is possible to provide the filter of a size sufficient for removing an amount of dust to be removed during lifetime that is estimated based on the useful life, by providing, in the fuel pump 22 or the fuel passage, the high-pressure filter that captures dust as abrasion powder and so on, generated in the fuel pump, and the like. Further, as compared with the size of the conventional filter, the size of the filter in the embodiment is reduced so that the size of the entire fuel supply apparatus is made small. Accordingly, the size and the weight of the fuel supply apparatus can be reduced.

Also, the fuel that has been sucked from the suction filter is directly delivered to the fuel passage on the downstream side of the fuel pump. Therefore, the passage leading from the fuel pump to the high-pressure filter is extremely short and simple. Accordingly, loss of pressure on fuel due to the inner wall of the passage does not occur.

The high-pressure filter is provided on the downstream side or the upstream side of the one-way valve so as to be adjacent to the one-way valve. Accordingly, the high-pressure filter can be mounted easily by using the position where the one-way valve is mounted, while the same effects as in the first embodiment can be achieved.

Further, since the high-pressure filter removes dust as abrasion powder and so on, generated in the fuel pump and the like, the conventional filter chamber can be omitted so that the size of the entire fuel supply apparatus is made small. Accordingly, the size and the weight of the fuel supply apparatus can be reduced.

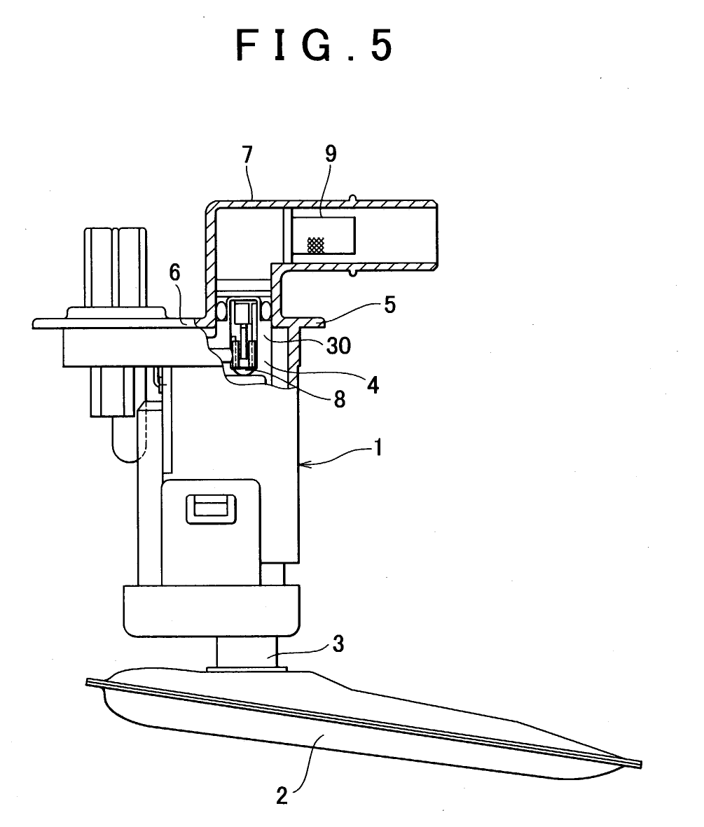

As a another example of embodiments, the fuel supply apparatus can locate the high-pressure filter 9 in the fuel passage 7 in horizontal direction as shown in FIG. 5.

What is claimed is:

1. A fuel supply apparatus comprising:
a fuel pump which discharges fuel,
a cover portion which is formed above the fuel pump,
a fuel passage which is provided in the cover portion; and
a high-pressure filter provided in at least one of the fuel pump and the fuel passage, and which removes dust in the fuel discharged from the fuel pump.

2. The fuel supply apparatus according to claim 1, wherein:
the fuel passage is tubular.

3. The fuel supply apparatus according to claim 1, wherein:
the fuel passage protrudes above the cover portion.

4. The fuel supply apparatus according to claim 1, further comprising:
a suction filter which is provided upstream of the fuel pump so as to remove dust in the fuel.

5. The fuel supply apparatus according to claim 1, wherein the high-pressure filter removes dust generated in the fuel pump.

6. The fuel supply apparatus according to claim 1, further comprising:
a one-way valve which is connected to the high-pressure filter.

7. The fuel supply apparatus according to claim 6, wherein the high-pressure filter is provided on a downstream side of the one-way valve.

8. The fuel supply apparatus according to claim 7, further comprising:
a suction filter which is provided upstream of the fuel pump so as to remove dust in the fuel.

9. The fuel supply apparatus according to claim 8, wherein the high-pressure filter is engaged with a stepped portion formed in the fuel passage which connects the one-way valve and the fuel pump.

10. The fuel supply apparatus according to claim 7, wherein the high-pressure filter removes dust generated in the fuel pump.

11. The fuel supply apparatus according to claim 6, wherein the high-pressure filter is provided on an upstream side of the one-way valve.

12. The fuel supply apparatus according to claim 11, wherein the high-pressure filter is engaged with a stepped portion formed in a space portion between the one-way valve and the fuel pump.

13. The fuel supply apparatus according to claim 12, further comprising:
a suction filter which is provided upstream of the fuel pump so as to remove dust in the fuel.

14. The fuel supply apparatus according to claim 11, wherein the high-pressure filter removes dust generated in the fuel pump.

15. The fuel supply apparatus according to claim 6, wherein the high-pressure filter is provided in plurality, one of the high-pressure filters being a first high-pressure filter, another high-pressure filter being a second high-pressure filter, the first high-pressure filter is provided on an upstream side of the one-way valve, and the second high-pressure filter is provided on a downstream side of the one-way valve.

16. The fuel supply apparatus according to claim 15, wherein the first high-pressure filter is engaged with a stepped portion formed in a space portion between the one-way valve and the fuel pump, and the second high-pressure filter is engaged with a stepped portion formed in a fuel passage that connects the one-way valve and the high-pressure filter and protrudes from an upper portion of the fuel pump.

17. The fuel supply apparatus according to claim 15, further comprising:
a suction filter which is provided upstream of the fuel pump so as to remove dust in the fuel.

18. The fuel supply apparatus according to claim 15, wherein the high-pressure filter removes dust generated in the fuel pump.

19. A fuel supply apparatus comprising:
a suction filter which removes dust in fuel;
a fuel pump which is connected to the suction filter by a connecting pipe through which the fuel that has passed through the suction filter is discharged;
a fuel passage which protrudes from an upper portion of the fuel pump; and
a high-pressure filter which is provided in the fuel passage so as to remove dust in the fuel.

20. The fuel supply apparatus according to claim 19, wherein the high-pressure filter removes dust generated in the fuel pump.

21. A fuel supply apparatus comprising:
a suction filter which removes dust in fuel;
a fuel pump which is connected to the suction filter by a connecting pipe through which the fuel that has passed through the suction filter is discharged;
a fuel passage which protrudes from an upper portion of the fuel pump;
a one-way valve which is provided at an inlet portion of the fuel passage; and
a high-pressure filter which is provided in a fuel passage on an downstream side of the one-way valve so as to remove dust in the fuel.

22. The fuel supply apparatus according to claim 21, wherein the high-pressure filter removes dust generated in the fuel pump.

23. A fuel supply apparatus comprising:
a suction filter which removes dust in fuel;
a fuel pump which is connected to the suction filter by a connecting pipe through which the fuel that has passed through the suction filter is discharged;
a fuel passage which protrudes from an upper portion of the fuel pump;
a one-way valve which is provided at an inlet portion of the fuel passage; and
a high-pressure filter which is provided in a space portion on an upstream side of the one-way valve so as to remove dust in the fuel.

24. The fuel supply apparatus according to claim 23, wherein the high-pressure filter removes dust generated in the fuel pump.

25. A fuel supply apparatus comprising:
a suction filter which removes dust in fuel;
a fuel pump which is connected to the suction filter by a connecting pipe through which the fuel that has passed through the suction filter is discharged;
a one-way valve which is provided at an inlet portion of the fuel passage;
a first high-pressure filter which is provided in a space portion on an upstream side of the one-way valve so as to remove dust in the fuel; and
a second high-pressure filter which is provided in the fuel passage on a downstream side of the one-way valve so as to remove dust in the fuel.

26. The fuel supply apparatus according to claim 25, wherein the high-pressure filter removes dust generated in the fuel pump.
